(19) United States
(12) Patent Application Publication
(10) Pub. No.: US 2008/0168270 A1
(43) Pub. Date: Jul. 10, 2008

(54) Electronic secure authentication for exchange buying system (eSafeBuy)

(76) Inventors: Michael Kulakowski, (US); Robert Kulakowski, (US)

Correspondence Address: Michael Kulakowski, 5 Carlson Court, Jackson, NJ, 08527, US

(21) Appl. No.: 12/002,810

(22) Filed: Dec. 19, 2007

Related U.S. Application Data
(60) Provisional application No. 60/876,249, filed on Dec. 21, 2006.

(51) Int. Cl. H04L 9/32

(52) U.S. Cl. 713/168

(57) ABSTRACT

The invention provides customers the ability to reserve, order, or purchase products or services directly from eCommerce providers, retailers, manufacturers, distributors, brokers, auctions and service providers (collectively referred to as “retailers”) in a safe and secure fashion by receiving authentication notifications and product certification throughout the ordering/purchase procurement process. It also facilitates the ability to read an RFID tag (or another identification/tagging mechanism) embedded within or attached to products and determine the product's manufacturer, supplier, retailer, model number, etc., and locate an identical/similar product based upon the eSafeBuy customer's preferences within the (physical or digital cyber-space) retail environment. Products that are reserved, ordered, or purchased are authenticated against being counterfeited, stolen, piracy, or unlawfulness by enacting an RFID “Cryptographic Authentication Challenge” as detailed within the “Security authentication system for collectible and consumer items” (U.S. patent application Ser. No. 11/157,282), or other secure authentication method.

### BRIEF SUMMARY OF THE INVENTION

Over the last few years, advances in the digital identification and tracking of products provide customers with the ability to search and acquire products from standard retail establishments, electronic commerce sites, a home, office, or from virtually any environment. By reading a given product's RFID tag (or other identification modality), an eSafeBuy customer can locate, reserve, order, or purchase an identical (or similar) product directly from the product's manufacturer, distributor, or retailer with such ‘located’ products being authenticated against being counterfeited from unauthorized manufacturers, pirated from unauthorized distributors or retailers, illegal, or that the product that the customer subsequently receives is a “swapped product” and not the original product the customer believed they had purchased. Customers so “cheated” by dubious vendors and practices often have no recourse but to absorb their “loss” and to be more diligent while participating in future purchase endeavors. The eSafeBuy system's security attributes verifies the authenticity of a product from its manufacturing point to its purchase and reception by a customer.

### BRIEF DESCRIPTION OF THE DRAWINGS

FIG. 1—Authenticate & Purchase ‘Button’ initiated process accessible from an ecommerce web page that commences the product's authentication process.

FIG. 2—Authentication Result, Purchase Recommendation, Authentication Details, Purchase button, View Incentives button & View Services button that the customer uses to purchase the product and view or include Incentives and Services corresponding to the authenticated product.

FIG. 3—Cellular Telephone Authentication Process Button used to authenticate products from a mobile device's electronic auction site that additionally displays auction bids placed on the subject product.

FIG. 4—Authentication Result, Purchase Recommendation, View Incentives button, View Services button, and Purchase link that is displayed on a cellular telephone's access of an electronic auction site.

FIG. 5—Authentication Results & Purchase button initiated process that details the authentication results and provides the ability to purchase the authenticated product on a cellular telephone's access of an electronic ecommerce site.

FIG. 6—Product Reservation Enactment process to reserve authenticated products for later purchase on a cellular telephone's access of an electronic ecommerce site.

FIG. 7—Cellular Telephone Direct Incentive Authentication Link Incentives offers that are presented to customers for authenticated products from within a “Purchase Authentication System” site.

FIG. 8—Cellular Telephone Direct Incentive Authentication Link Services offer details that are presented to customers for authenticated products from within a “Purchase Authentication System” site.

FIG. 9—Authenticated Results upon Product Delivery/Reception authentication process.

### DETAILED DESCRIPTION OF THE INVENTION

This invention establishes a means to enact secure and authentic product purchases from within either a home, office, retail, or non-retail environment by utilizing a secure and authenticated digital device connected to a secure authenticated telecommunication network or computer network as detailed within the “Secure RFID authentication system” (U.S. patent application Ser. No.: 11/268,162), or other secure authentication methods, and “Secure RFID Authentication System using non-trusted communications agents”, or other secure communication methods, technology created and presented within (patent application Ser. No. 11/728,792) filed by Michael Kulakowski and Robert Kulakowski.

A secure and authenticated digital device defined within this invention consists of, but is not limited to the following: a cellular telephone (preferable embodiment), an RFID Reader, Personal Digital Appliance PDA, Personal Computer, Laptop or Notebook computer, electronic wallet or any other form of electronic (RFID reading or Secure ID reading) device that can be authenticated to a Secure Telecommunication Computer Network, collectively referred to as a conforming eSafeBuy device.

In this patent application the term “eSafeBuy conforming cellular telephone” is used as a generic term for a cellular phone, personal computer, web browser, PDA, Set Top Box, video player, music player, game player, or other computer or electronic device that can be used to perform some or all of the functions described in this patent application and is not limited to only cellular phones.

An eSafeBuy customer may shop from a non-secure regular cellular phone or a secure eSafeBuy on-line website or telecommunication hosted site providing cellular telephone access, or preferably at an “electronic Secure Authentication For Exchange Buyer Assurance System—eSafeBay” auction (U.S. patent application Ser. No. 60/876,308 filed by Michael Kulakowski and Robert Kulakowski) or eCommerce site where products to be purchased have their authentication data presented to customers prior to the purchase transaction. For the product location portion of this invention normal computers or cellular phones can be used to find products that are within the physical proximity to the consumer or a designated search location such as within 3 miles of the next airport someone is arriving at. The basic concept of the product location finder portion of this invention is that a person can locate a product using their navigation system enhanced with product location services whereby a navigation system can identify stores within an area when searching for products within a certain area by detecting stores within the area and then checking the store status for the desired product. The basic concept of the product location finder portion of this patent does not require the authentication elements described in this and prior patents and can be used in a standalone manner. In addition, the basic product location finder portion of this invention does not even need RFIDs and product location information can be obtained using barcodes or product IDs (not stored in RFIDs but printed on a product) and other non-RFID identifiers that can be used to indicate a product or products for which the nearest physical location can be found.

When the product is received, the eSafeBuy customer uses their eSafeBuy authenticated cellular telephone to verify that the purchased product they have in their possession is the exact authenticated/certified product that was initially ordered by commencing a real-time product re-authentication.

This invention also establishes a wi-fi “wireless local area networks” (WLAN) connection between an eSafeBuy customer's computer system and their eSafeBuy conforming device through the integration of a secure authenticated by the inventive nature of this invention wireless router “access point” using commercially available non-authenticated access points. The eSafeBuy conforming device functions as a connected device to the wireless router and allows for the exchange of digital data between the devices and the digital data can optionally be secured via encryption or other methods by the eSafeBuy technology described in this invention. An a eSafeBuy customer may shop on the eSafeBuy website and transfer their purchase details onto their cellular telephone to enact an authentication challenge once the eSafeBuy purchased product is received at their home or office. Likewise, products that were purchased from a retailer's telecommunication hosted shopping domain that is utilizing the technology specified within the “Security authentication system for collectible and consumer items” (U.S. patent application Ser. No. 11/157,282), are capable of having their authenticated product and its purchase details transferred from their eSafeBuy conforming cellular telephone to their computer systems. An eSafeBuy customer may transfer authenticated product data and purchase details from their eSafeBuy conforming cellular telephone to other eSafeBuy conforming cellular telephone belonging to family members, friends, and/or co-workers. The eSafeBuy user may also transfer unauthenticated product data into their cellular phone, computer, notebook computer, PDA, Set Top Box, music or video player or other digital device.

Another element of this invention centers upon an eSafeBuy customer's ability to place orders with retailers by interrogating, reading or scanning RFID tags (attached to or inserted within products) directly into their conforming cellular telephone's RFID reader for immediate purchase or for the compilation of a shopping list or services request list.

The eSafeBuy System computer network relies on the integration of RFID tag Electronic Product Code data and logistical data to be collected and utilized to determine a product's availability and location —logistical data within-the vast retail environment. By providing a product's RFID tag data read from a conforming eSafeBuy RFID reader, identical or similar products to the read product's RFID tag are located within the eSafeBuy retail environment or from an external retail environment. Any product that has its RFID tag read or searched returns relevant data, including, but not limited to: the retailer's identity, product details, and the product's availability and anticipated pick-up or ship dates. The basic data returned from the actual RFID can optionally be augmented with other data not contained in the RFID itself and an example of such data is the retailer's identity, product pricing, product location within the store, and other product related data described within this patent application, and other extraneous product related data.

By searching the eSafeBuy on-line electronic commerce site via a browser of any sort, or a product search application, or an eSafeBuy conforming cellular telephone, product's may be located within the eSafeBuy real-time “eshopping Mall” offering eSafeBuy customers the maximum level of insurance to a product's e-pedigree, validation, and authenticity against counterfeiting, pirating, being stolen, damaged, recalled, unlawful, recalled, etc. And, with the location services provided by this invention a product can be found within the shortest geographic location to a location with verification that the product is in stock and optional authentication of the products validity.

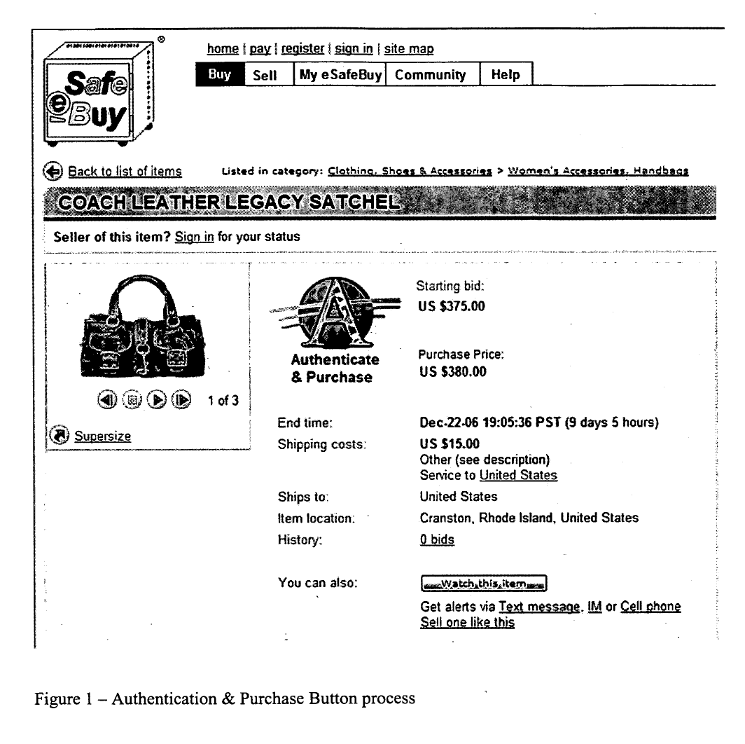

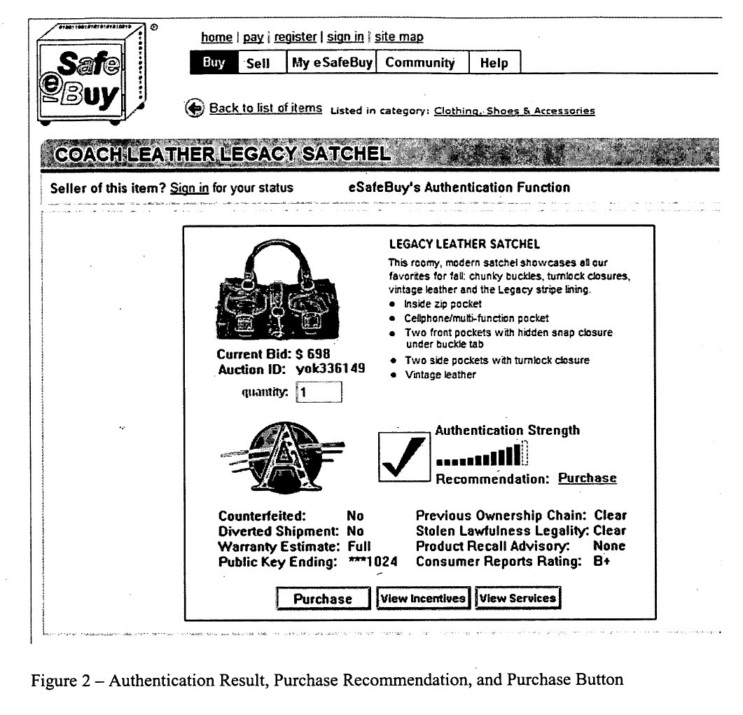

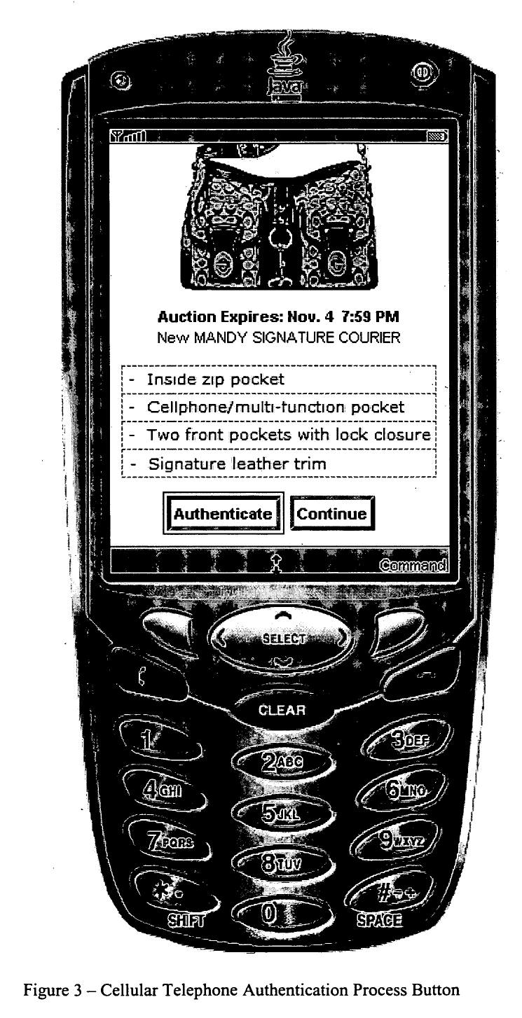

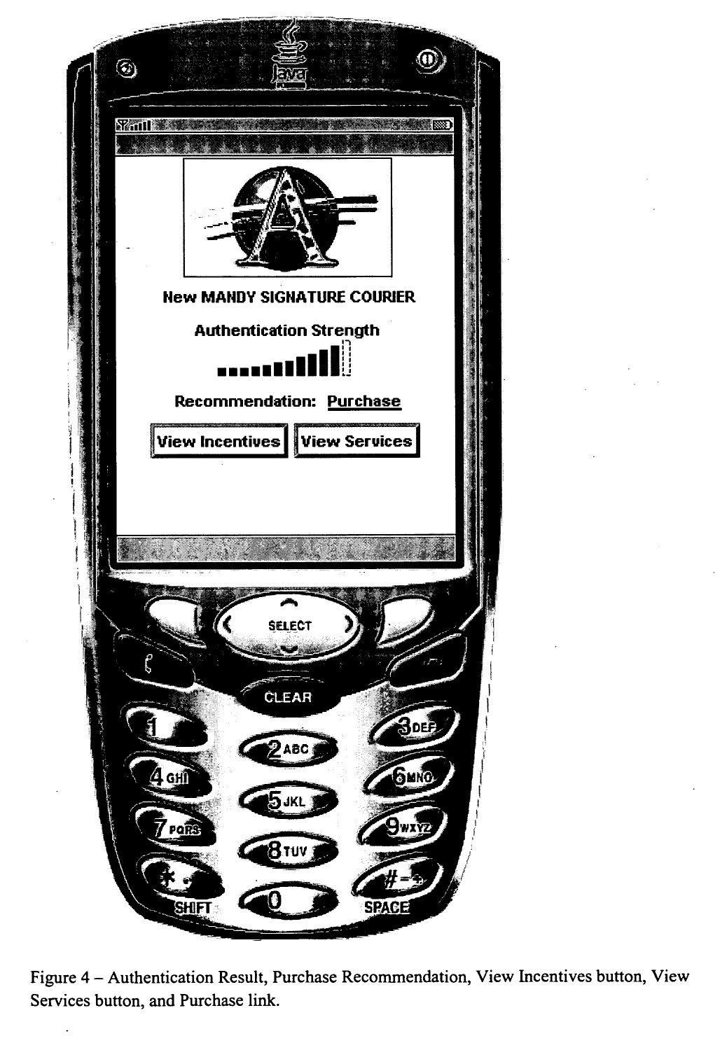

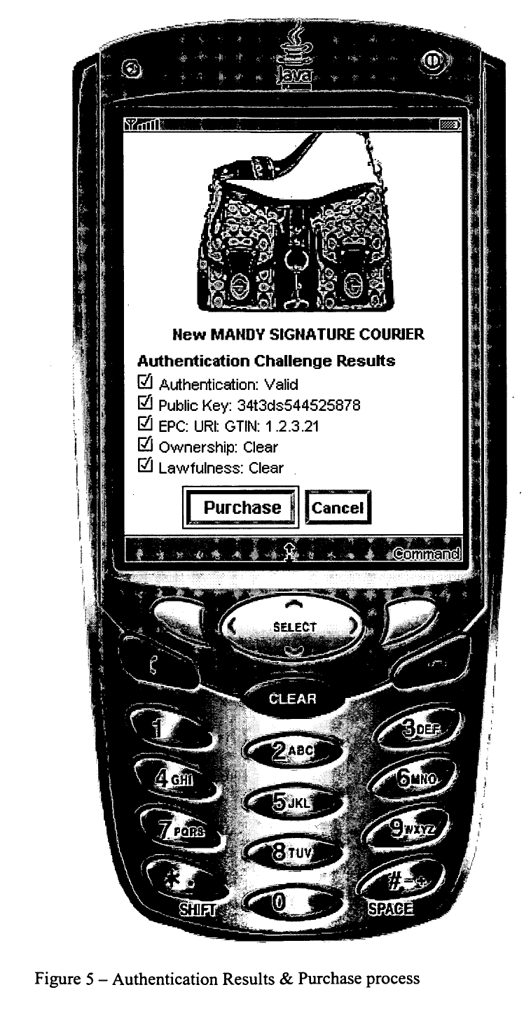

An eSafeBuy customer's pressing or clicking of an “A” Authentication button (physical or display based menu button) facilitates the initiation of an Authentication Challenge on any product considered for purchase (FIG. 1, FIG. 3). The results of the challenge are conveyed to the eSafeBuy customer's cellular telephone or computer and a recommendation is generated advising the customer to purchase the product or abort the purchase process (FIG. 2, FIG. 4, FIG. 5).

The eSafeBuy “Purchase Authentication System” or eShopping Mall extends the greatest reliability and conformance to the aforementioned technologies consistent with the: “Security authentication system for collectible and consumer items” (U.S. patent application Ser. No. 11/157,282), “Secure RFID authentication system” (U.S. patent application Ser. No. 11/268,162), “Secure RFID Authentication System using non-trusted communications agents” (U.S. patent application Ser. No. 11/728,792, “Direct Incentive Authentication Link (U.S. patent application Ser. No. 11/881,506), and the electronic Secure Authentication For Exchange Buyer Assurance System (U.S. Patent Application No. 60/876,308 Filed Dec. 21, 2006), all invented and filed for patent by Michael Kulakowski and Robert Kulakowski.

The eSafeBuy system strives to insure that external retail sources meet the same level of eSafeBuy stringent security and authentication requirements (or other secure authentication methods) of the patented technologies above, and that the retailer's identity, its performance reliability, product authenticity successes and failures, delivery history, and customer service rating are available to eSafeBuy customers.

### Immediate Direct Purchases:

In the case of an eSafeBuy customer's enactment of an immediate purchase request for a desired product (previously purchased from a manufacturer, retailer, distributor, supplier, broker, etc.,) the product's RFID tag's EPC code is read (as above) by a conforming cellular telephone's RFID reader and the associated data is presented to a “Global EPC Registry and Lookup Service Provider” or similar service provider, or a Trust Authority that identifies the manufacturer, retailer, distributor, supplier, broker, etc, offering or responsible for the purchase of the desired product. Upon successful identification of the product from within the EPC registry or Trust Authority, the products relevant RFID and product data such as, but not limited to (manufacturing details, model, size, color, participating retailers offering the product, its usage and safety details, price, availability, release dates, anticipated ship dates, etc.) are communicated to the eSafeBuy cellular telephone, or a conventional web based browser or other user interface display or display device. The eSafeBuy customer then requests a listing of retailers offering the product for sale meeting their specific pre-defined characteristics and then selects a retailer from which to purchase the product from. At that time, the eSafeBuy customer's conforming cellular telephone automatically creates and submits a product purchase request that is communicated to the selected retailer. The retailer responds by acknowledging the request and optionally returns the product's trusted encrypted public key element and any relevant pre-purchase details. Once the trusted encrypted public key is obtained, the customer may optionally conduct a real-time partial authentication challenge (see below) and eventually can optionally issue a full authentication challenge once the order product is received.

Conversely, an eSafeBuy customer may enact an Immediate Direct Purchase action from within a retail environment by reading the RFID tag of a product residing within a retail store. The authenticated retailer's eSafeBuy system acknowledges the purchase request as originating from a conforming eSafeBuy customer cellular telephone located within their node of the eSafeBuy network (as specified within the “Secure RFID authentication system using non-trusted communication agents” (U.S. patent application Ser. No. 11/728,792). The retailer's eSafeBuy System distributes the product's trusted encrypted public key to the customer's eSafeBuy cellular telephone for usage within a real-time authentication challenge (“Security authentication system for collectible and consumer items” (U.S. patent application Ser. No. 11/157,282). Another embodiment of this invention substitutes non-RFID identifiers such as a products UPC code value, a products model number, manufacturer or product description in place of RFID identification allowing products without an RFID tag to be located using the product location services of this invention. This means that products without an RFID tag can be part of the product location services described within this patent application.

Should the authentication challenge return a Pass/Valid result, the eSafeBuy customer is advised to conduct the transaction. eSafeBuy customers may also receive “DIAL Incentive Offers” or “Enhanced Additional Service” offerings associated with their product purchase as those contained within the “Direct Incentive Authentication Link (DIAL) System” (U.S. patent application Ser. No. 11/881,506) as enumerated within the “Enhanced Additional Services” section below.

Any authenticated incentive offers extended to an eSafeBuy customer's via their conforming cellular telephone corresponding directly to the authenticated product may be accepted by the eSafeBuy customer at that time or thereafter at a later time. Accepted incentive offers impact the financial settlement of the product being purchased and are duly recorded within the eSafeBuy system.

An example of an eSafeBuy Immediate Direct Purchase benefit to eSafeBuy customers involves a shopping excursion by a husband and wife whereas the wife finds a unique china vase that she “absolutely falls in love with”. The husband, using his conforming eSafeBuy cellular telephone reads the vase's RFID tag and secretly performs an authentication challenge on the vase using the product's trusted encrypted public key obtained from a Trust Company (such as VeriSign or any other participating trust authority). The encrypted public key for a RFID authentication challenge is then passed to the product's RFID tag and should an algorithmic match exist between the encrypted public and private keys, the RFID tag signals a Pass/Valid response to the conforming eSafeBuy cellular telephone RFID reader that displays the pass result to the cellular telephone's display, vibratory pattern, flashing, etc.

In this husband and wife shopping example, the husband accepts an “Enhanced Additional Service” offer from the retailer to provide free immediate delivery to his home. He then transfers the details of the transaction to his son's conforming eSafeBuy cellular telephone with a message asking him to accept delivery of the vase, should it once again pass an authentication challenge upon the product's delivery. The son's conforming eSafeBuy cellular telephone, armed with the product's corresponding encrypted public key, is then used to conduct an authentication challenge once the product arrives at his door. The product's authentication challenge is successful returning a Pass/Valid message to the conforming eSafeBuy cellular telephone. The son takes possession of the vase, and details of the successful authentication challenge and its delivery confirmation are automatically communicated to his father's conforming eSafeBuy cellular telephone. Upon the husband's and wife's return home, the wife is amazed to find the exact vase she cherished awaiting her.

She then decides to take advantage of a previously delivered “Direct Incentive Authentication Link” transferred to her conforming eSafeBuy cellular telephone by her husband and orders a matching china serving tray at a 20% discount with free delivery.

She creates and submits a product purchase request for the serving tray that is communicated to the selected retailer. The retailer responds by acknowledging the request and returns the product's trusted encrypted public key element and any relevant pre-purchase details. Once the trusted encrypted public key is obtained, the customer may conduct a real-time partial authentication challenge (see below) and eventually a full authentication challenge once the order product is received.

For Failed or Invalid challenge results, the eSafeBuy customer is advised to abort the transaction and the authentication challenge results and associated data is recorded within the eSafeBuy System's computers. Products suffering a failed authentication challenge are not eligible to access “DIAL Incentive Offers”.

### Shopping/Registry List Creation:

Similarly, when comprising a shopping or registry list of products for later purchase, the product's RFID tag's EPC code is read (as above) by a conforming cellular telephone's RFID reader and the associated data is presented to a global EPC registry and lookup service provider or Trust Authority that identifies the manufacturer, retailer, distributor, supplier, broker, etc, offering or responsible for the purchase of the desired product. Upon successful identification of the product from within the EPC registry or Trust Authority, the products relevant RFID and product data such as, but not limited to (manufacturing details, model, size, color, participating retailers offering the product, its usage and safety details, price, availability, release dates, anticipated ship dates, etc.) are communicated to the eSafeBuy cellular telephone and stored for later usage.

When the eSafeBuy customer decides to order the product contained within their stored shopping list, the customer requests a listing of retailers offering the product for sale meeting their specific pre-defined characteristics and then selects a retailer from which to purchase the product from.

At that time, the eSafeBuy customer's conforming cellular telephone automatically creates and submits a product purchase request that is communicated to the selected retailer. The retailer responds by acknowledging the request and returns the product's trusted encrypted public key element and any relevant pre-purchase details. Once the trusted encrypted public key is obtained, the customer may conduct a real-time partial authentication challenge (see below) and eventually a full authentication challenge once the order product is received.

A partial authentication challenge involves the establishment of a (possible simultaneous) connection to a Trust Authority that verifies the appropriateness and validity of the product's public key (previously provided by the retailer to the eSafeBuy customer) to the product's stored public key and ancillary RFID electronic product code and associated data that is stored and maintained by a Trust Authority (such as VeriSign).

Should a preliminary assessment of the retailer's data algorithmically match the Trust Authorities (such as VeriSign) public key and associated data, the customer is advised to complete the transaction for the desired product and the products public key is stored within the customer's eSafeBuy cellular telephone and/or computer system.

When the public key (previously provided by the retailer to the eSafeBuy customer) fails validation and/or is deemed in-appropriate and does not algorithmically match the product's stored public key maintained by a Trust Authority (such as VeriSign), the eSafeBuy customer is advised to “abort the transaction”. Should the eSafeBuy customer's settings automatically prevent the purchase of products resulting in an Authentication Failure, the failed authenticated product is optionally automatically blocked from being purchased.

### Product Location Service:

Alternatively, an eSafeBuy customer may request that products desired for immediate purchase or products residing on their shopping list be located within a certain geographical area and/or purchased from or offered for sale by specific retailers. An example of a “product location request” service depicts an eSafeBuy customer's desire to locate a hard to find Sony Play Station 3 Game (PS3) Console within a retail environment and initiates a “product location request” that attempts to ‘digitally’ locate the product by querying the retailer's computer systems for availability of the PS3 within the specified area and or preferred retailers. As described earlier, the product location request can be based on non-electronic IDs such as current day printed barcode technology and do not have the authentication elements of this patent but also provides new novel features such as the capability of finding a product from a product description, a product id, a product bar code, or a products RFID within a geographic region and this technology can be integrated into computers, web browsers, cellular phones and even Global Positioning Navigation systems where the GPS display becomes part of a product ID location service and the location of the desired product can be mapped by the GPS system or the computer, browser, cellular phone, etc. In addition, it is envisioned that many items from different manufacturers can be automatically located and the retailer with the most items in stock or the best pricing on the items can automatically be determined from the location element of this invention with or without RFID product authentication.

### Product Reservations

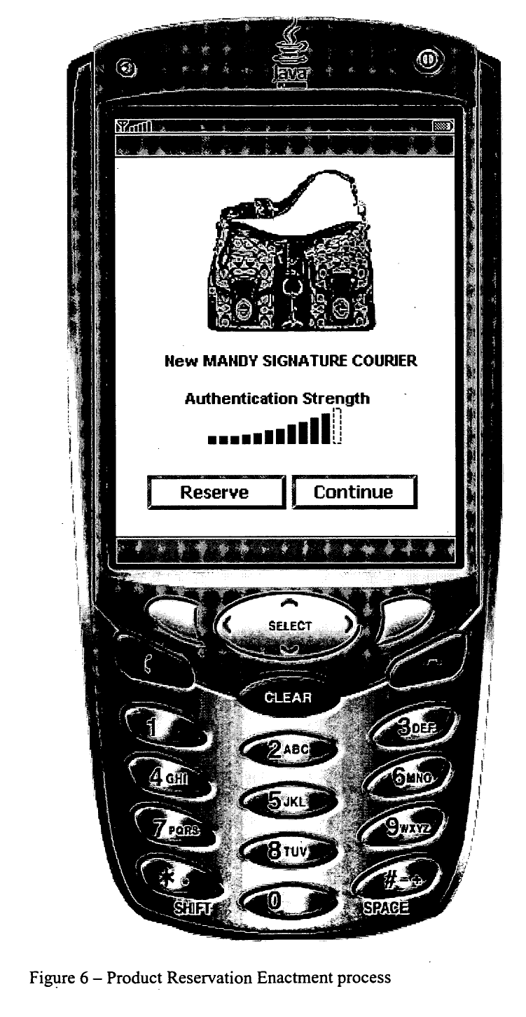

In instances where a sought after product is digitally located, an eSafeBuy customer may place a digital “hold & reservation” (FIG. 6) on that product for their exclusive purchase and arrange for its subsequent pick-up or delivery. The eSafeBuy customer has a predetermined “reservation period” for the located product and must purchase that product from the given retailer before the reservation lapses. When a reservation lapses, an eSafeBuy customer may “renew a reservation” on the product should the product remain available without any other “holds” placed upon it. In situations where an eSafeBuy offered product is in short supply and is currently reserved by a particular eSafeBuy customer, another eSafeBuy customer may be placed on a “waiting list” should the initial eSafeBuy customer's reservation lapse as described above. Should the reservation lapse on a reserved product, the next eSafeBuy customer is automatically advised of the current availability of the product and given the opportunity to place their own “hold” on that product or enact an immediate purchase transaction.

### Purchase Incentive Offers

Considering the availability of a product for purchase, the retailers may attempt to “complete the transaction” by presenting to eSafeBuy customer a real-time incentive offer specifically designed for the product under purchase consideration or reservation and/or the relationship the eSafeBuy customer has established with the retailer.

Such a purchase incentive offering extended from a retailer directly to an eSafeBuy customer for a specific product that has been read, scanned or interrogated by a conforming eSafeBuy cellular telephone constitutes an incentive offer as contained within the “Direct Incentive Authentication Link—DIAL System” (U.S. patent application Ser. No. 11/881,506 filed by Michael Kulakowski and Robert Kulakowski).

### DIAL Incentive Offers:

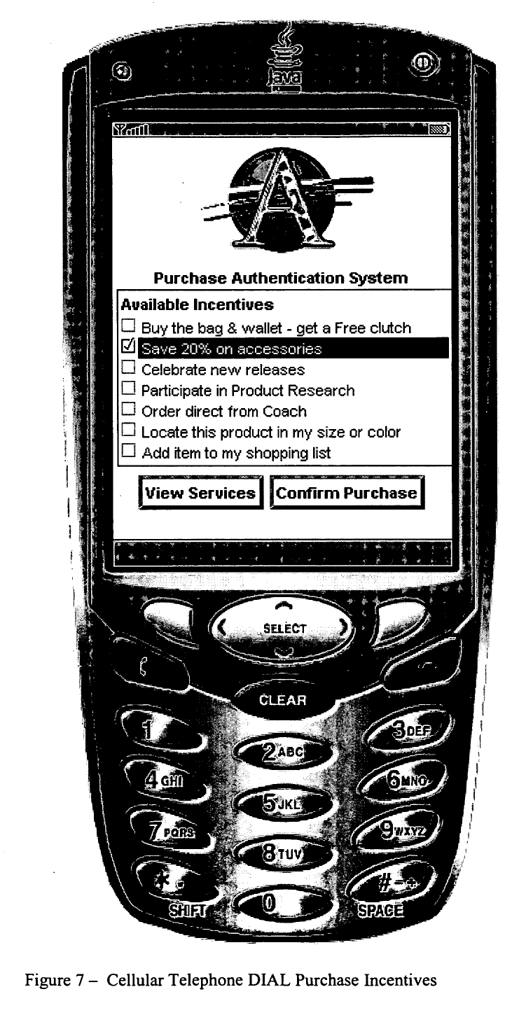

An eSafeBuy presentation of DIAL Incentive Offer messages (FIG. 7) may include, but are not limited to:

| | |
|---|---|
| Savings | Save 20% on this item |
| | Save 10% on associated accessories |
| Bonus | Free Item: Buy the pocketbook now & |
| | receive a free matching wallet |
| | Earn Points: Earn double bonus points for |
| | this purchase |
| Locate | Locate this product in my: |
| | Area, Size, Color, Model, etc. |
| Order | Direct from Manufacture if the desired item |
| | is not available for purchase immediately |
| | from the Retailer |
| Compose List | Add this item to my shopping/wish list |
| | Add this item to my Gift/Wedding registry |
| Invitation | Complete a product satisfaction survey |
| | Suggest how we can make this product |
| | better |
| | Join our Frequent Buyers Club |
| | Receive new product announcements |
| Enrollment | Participate in a Product Launch Celebration |
| | Subscribe to a ‘branded’ life style magazine |
| | Contribute toward Product Research & |
| | Testing |
| | Join a Product Focus Group |
| | Enroll in Product Protection/Service Plan |
| Credit Card | Increase your Credit Limit |
| | Use your Bonus Rewards toward this |
| | purchase |
| | Upgrade your Credit Card Club Level |
| | Earn Double Bonus Rewards |
| Added | Include complimentary Services with this |
| Services | purchase |

DIAL Incentive Offer System messages insures the appropriate level of security and authentication between the Manufacturer, Retailer, Credit Card Company or Distributor and the Trusted Authority is established using an encrypted communication service link (FIG. 2) that is comprised of a unique (Manufacturer, Retailer, Credit Card Company, or Distributor) id (or an encrypted unique id) and an associated public key previously provided by the Trust Agency. A real-time authentication challenge is established between the Trust Authority and the Retailers whereby the communication channel transfers a dynamic encrypted security algorithm that is cross-referenced and authenticated in either direction between: a Trust Authority—Manufacturer with a public key transferred along with a unique seed id. Subsequent Incentive Offers employ this cryptographic key authentication for a predetermined duration of time. Consumer activity consistent within a shopping environment or process resets the cryptographic key's lifespan and is used until its expiration due to inactivity or the intentional termination of the connection by either the consumer or the Retailer. Additionally, events such as leaving a Retailer's environment, website, telecommunication hosted domain, acceptance of the Incentive Offer, or completing the transaction for the product subject to the Incentive Offer may terminate the existence of the cryptographic key.

A series of DIAL notification icons/text convey state information to the consumer's electronic device, such as, but not limited to:
Establishment of a connection to the Trust Authority
Cellular telephone or electronic device authentication by the Trust Authority
Results of a product's authentication challenge
Establishment of a Retailers connection based upon the product's public key
Authentication of the Retailers
Retrieval of the associated DIAL Incentive Offer Message(s)
The consumer's acceptance of an available DIAL Incentive Offer Message
Completion of the transaction that includes the impact of the DIAL Incentive Offer

Acceptance of a Direct Incentive Authentication Link offer directly impacts the terms of the transaction and becomes part of the transaction record. Should an eSafeBuy customer initially decline the DIAL incentive offer, but wish to later “revive” and enact the DIAL incentive offer on a completed transaction, a retailer may honour the elapsed DIAL incentive offer and adjust the transaction record accordingly.

eSafeBuy Purchase Product Reception:

Once the ordered product is received by the eSafeBuy customer, the customer uses their conforming eSafeBuy cellular telephone's RFID reader to transmit the previously stored corresponding product's public key to the actual product's physically embedded or attached RFID tag thereby commencing an RFID authentication challenge commensurate with the technology incorporated within the “Security authentication system for collectible and consumer items” (U.S. patent application Ser. No. 11/157,282), or other secure authentication method and “Secure RFID authentication system” (U.S. patent application Ser. No. 11/268,162).

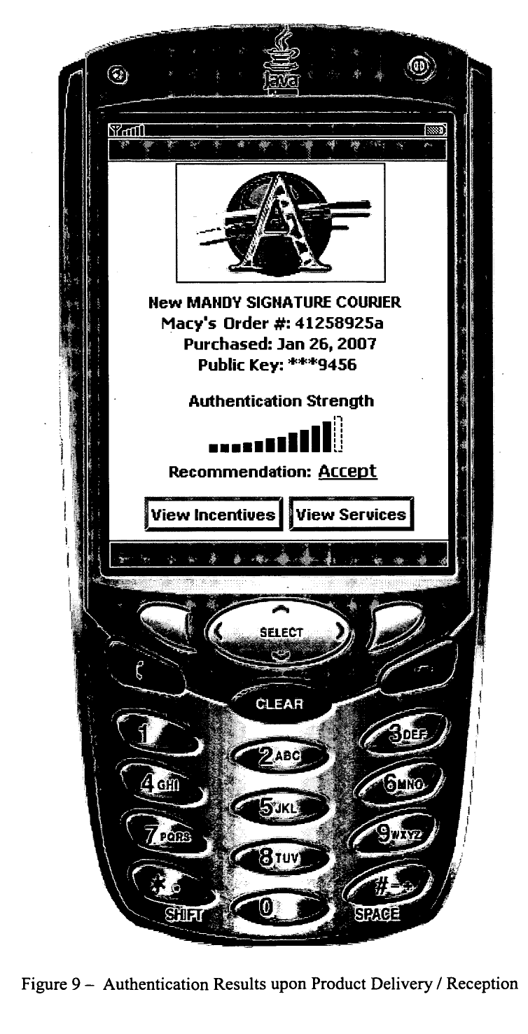

Should the product's encrypted public key algorithmically match the internal encrypted private key of the product's RFID tag, the product is considered to have passed the authentication challenge (FIG. 9). At this point, an eSafeBuy customer is advised to accept the product as the “real product” identified at the point of purchase and incorporated. within the eSafeBuy purchase order and purchase contract.

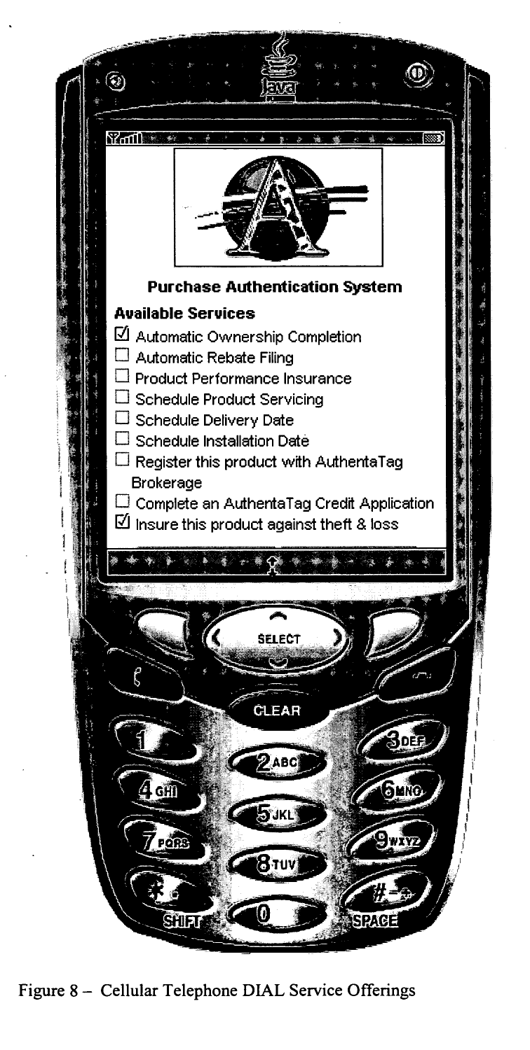

eSafeBuy customers may also receive enhanced additional service offerings (FIG. 8) associated with their product purchase as those contained within the “Direct Incentive Authentication Link (DIAL) System” (U.S. patent application Ser. No. 11/881,506) consisting of, but not limited to:

### Enhanced Additional Services:

Electronic Ownership Registration
Electronic Completion and Electronic Filing of Rebates
Product Service Plans
Product Performance Insurance Plans
Automatic Periodic Authenticated Product Ordering Agreement
Collateralization Services
Electronic Product Appraisal Services
External Product Appraisal Services
Product Valuation Certificates & Product Ownership Certificates Services
Broker Services
Direct Incentive Authentication Link Post Purchase Offer Availability

For acceptance of services that result in a financial charge, such charges are charged to the eSafeBuy customer and a financial settlement is conducted between the eSafeBuy customer and the eSafeBuy System on behalf of the service provider. All accepted services become part of the eSafeBuy customer transaction record and become part of a binding contract between the eSafeBuy customer and the eSafeBuy System and the service provider.

All selected service that are offered to and/or accepted by eSafeBuy customers are authenticated by the DIAL system and validated as legitimate prior to impacting the product's purchase transaction and the authentication results becomes part of the transaction record.

### Service Revival:

Should an eSafeBuy customer decline to participate in a previously presented DIAL system incentive offer or service. at the time of purchase, the retailers may elect to later extend the availability of the previously presented offer or services. In such a situation, the eSafeBuy customer would need to interrogate or read their product's RFID tag with their eSafeBuy conforming cellular telephone and transmit via an authenticated on-line or telecommunication request their intention to accept a post-purchase incentive offer of service that was previous offered. Or, if supported by the application on the cellular phone the old message that contained the offer, incentive, service, registration, etc. can be used to complete the desired transaction.

Should the eSafeBuy customer's request to enact a previously presented service be re-activated by the retailer or service provider and is accepted by the eSafeBuy customer, the desired services become part of the eSafeBuy customer records as a binding contract between the eSafeBuy customer, the eSafeBuy System and the service provider.

### Automatic Product Procurement:

An eSafeBuy customer may establish an automatic scheduled purchase and delivery of specific -products within the eSafeBuy System by composing a listing of products they wish to purchase on a continuous basis—as an Automatic Product Procurement List. The eSafeBuy customer searches the on-line eSafeBuy “Shopping Mall” web pages from a secure authenticated computer or the secure telecommunication hosted eCommerce site using a conforming eSafeBuy cellular telephone to read a product's RFID tag (as above). The products are added to the Automatic Product Procurement List upon the successful authentication and validation (as specified above). Once the eSafeBuy customer enrolls the desired product(s) into their own Product Procurement Listing, the customer can schedule and also indicate their: vendor preference, automatic purchase schedule, shipment & delivery mode, etc. in accordance to their particular needs. The Automatic Product Procurement List purchase process invokes the same level of authentication as stipulated above and communicate to the eSafeBuy customer the authentication challenge results, product identification details, shipment details and tracking identification numbers, transaction charges and anticipated product delivery dates.

An example of a Product Procurement Listing enactment centers upon an eSafeBuy customer's purchase of an expensive bottle of wine that is automatically ordered, purchased, insured, and delivered to their home on a monthly basis. The customer receives a confirmation notification of the automated wine order, the bottle's public key for a partial authentication challenge, serial number, purchase transaction details, and FedEx delivery date and tracking number. Also, the eSafeBuy customer's eCalendar is updated with the purchase details, shipped and delivery dates. At the time of delivery, the eSafeBuy customer can perform a full authentication challenge to guarantee the e-pedigree of the wine.

Additionally, should a retailer present DIAL incentive offers to the eSafeBuy customer that has ordered products under the Automatic Product Procurement List process, such DIAL offers are extended to the eSafeBuy by the eSafeBuy System on behalf of the retailer and then may be accepted in accordance with the aforementioned DIAL safeguards previously described.

### Continuing Service Scheduling:

An esafebuy customer may establish an automatic Continuing Service Schedule within the eSafeBuy System by composing a listing of services that are to be performed on a regular scheduled basis. Such services, once established are electronically cleared with the eSafeBuy customer's eCalendar and scheduled into the eCalendar (if a conflict does not exist). Pre-service notifications prior to the performance of the schedule scheduled are automatically transmitted to the service recipient.

An example of a Continuing Service Schedule enactment centers upon an eSafeBuy customer's enrollment for periodic piano tuning services performed within their home. Pre-service notification and performance rating (and/or lawfulness evaluations) are conducted to insure the qualifications of the service provider and their continued “good standing” within the eSafeBuy System.

1. A system to securely authenticate an item or product offered for sale, comprising:
an electronic circuit associated with the item wherein the electronic circuit includes an electronically readable identifier and embedded cryptographic data and a cryptographic calculator to encrypt a response to a challenge received by the electronic circuit using the embedded cryptographic data, the embedded cryptographic data being an encryption key and other cryptographic data related to the electronic circuit;
an authenticating entity that stores the electronic readable identifier and the encryption keys associated with the embedded cryptographic data;
a reader configured to bi-directionally communicate wirelessly with the electronic circuit;
a network connection connecting the reader to the authentication entity wherein the reader is configured to communicate at least the electronically readable identifier and the encrypted response;
a validation module to execute a validation process configured to be initiated by the authentication entity or the reader, the validation process computes an expected response using the electronically readable identifier, stored encryption keys and the stored embedded cryptographic data to validate the encrypted response by comparing the expected response to the encrypted response; and wherein the authentication entity is configured to provide an authenticity indicator to indicate a result of the validation process

2. The system of claim 1, wherein said authenticity is established within a secure eCommerce shopping environment or conventional shopping environment for the secure acquisition of products and services

3. The system of claim 2, wherein secure authenticated digital devices are employed to purchasing products and services

4. The system of claim 3, wherein products to be purchased are authenticated whereas Pass or Fail authentication challenged results that are conveyed to the customer's authenticated digital device

5. The system of claim 3, wherein a digital device is securely authenticated within a secure trusted telecommunications computer network

6. The system of claim 2, wherein products can be physically located or digitally located (in cyberspace) from authenticated eCommerce sites, retailers, manufacturers, distributors, brokers, auctions and service providers, for reservation, ordering, or purchase

7. The system of claim 2, wherein products located from eCommerce sites, retailers, manufacturers, distributors, brokers, auctions and service providers are eligible to be reserved by placing a digital “hold or reservation” on the desired product for a specific duration of time

8. The system of claim 2, wherein customers may enroll on a “waiting list” for desired products should such products be previously “held or reserved”. Should the original “hold or reservation” be disqualified due to a lapse in time because of a failure to purchase the desired product by the original eSafeBuy customer, the first eSafeBuy customer of the “waiting list” is automatically informed via digital communication to their cellular telephone, email, home phone, fax, etc. that they are now eligible to place a reserve on the desired product for purchase within a specific period of time or to directly purchase the product from the retailer.

9. The system of claim 2, wherein a method provides “real-time” checking of a product's availability and inventory at an ecommerce site or retail location wherein said product is identified by one of a plurality of methods to identify the product including: a non-electronic product ID, a non-electronic product barcode, an electronic product ID such as RFID, electronic product code, and other product data; whereby said stock availability is determined by identifying the location point where the search should be centered and then the method of this invention queries all the stores within the said search center for product stock and then prepares a digital report indicating the location(s) where the complete list or a partial list of said products can be located

10. The method of claim 9 wherein the digital report includes ordering instructions or driving directions to one or more locations where the product is located or available from a merchant

11. The method of claim 9 wherein the digital report provides product pricing values

12. The method of claim 9 wherein the digital report can be transmitted to a Global Positioning System, a GPS system's display, computer, browser, or cellular phone and not necessarily the device used to initiate the product search.
